(19) United States
(12) Patent Application Publication
(10) Pub. No.: US 2025/0168936 A1
(43) Pub. Date: May 22, 2025

(54) Warming Tray

(71) Applicant: Chongpu Wu, Chibi (CN)

(72) Inventor: Chongpu Wu, Chibi (CN)

(21) Appl. No.: 19/027,342

(22) Filed: Jan. 17, 2025

(51) Int. Cl. H05B 3/34; H05B 3/12

(52) U.S. Cl. CPC H05B 3/34; H05B 3/12

(57) ABSTRACT

An improved warming tray is provided, and relates to the technical field of waring trays. The improved warming tray includes an integrally formed flexible housing and a locking structure arranged at an edge of the flexible housing; the locking structure is configured to lock a rolled state of the improved warming tray and prevent an edge of the flexible housing from being upwarped; at least one end of the flexible housing has an opening formed into a bag-shaped structure; a heating film is detachably arranged in the flexible housing; and the heating film is put into the flexible housing or taken out of the flexible housing through the opening. By designing the heating film that is detachably mounted in the integrally formed flexible housing, the heating film can be taken out of the integrally formed flexible housing when damaged.

### TECHNICAL FIELD

The present disclosure relates to the technical field of warming trays, and in particular, to an improved warming tray.

### BACKGROUND

Production and use of a traditional warming tray have the following disadvantages:

1. Complex structure: A front surface and a rear surface of a heating film need to be coated with a treating agent (similar to glue); the heating film is adhered between an upper silica gel plate and a lower silica gel plate; and the heating film and the two silica gel plates are pressed to be molded through a press. The process is tedious.

2. Large weight: The treating agent coated has a weight, which increases the weight of the product.

3. Poor heating efficiency: Due to the thermal insulation characteristic of the treating agent, the heat conduction efficiency of the heating film is low.

4. Unmaintainable feature: Once the heating film is damaged, the entire product cannot be used and needs to be directly replaced.

5. Inconvenience of storage: The conventional product has no hard clamp. After the product is rolled up for long time, an edge of the product is easily upwarped, which affects subsequent use and the appearance.

### SUMMARY

The present disclosure provides an improved warming tray, which can at least solve some defects in the prior art.

To achieve the above objective, an embodiment of the present disclosure provides the following technical solution: An improved warming tray includes: an integrally formed flexible housing and a locking structure arranged at an edge of the flexible housing, wherein the locking structure is configured to lock a rolled state of the improved warming tray and prevent an edge of the flexible housing from being upwarped; at least one end of the flexible housing has an opening formed into a bag-shaped structure; a heating film is detachably arranged in the flexible housing; and the heating film is put into the flexible housing or taken out of the flexible housing through the opening.

Further, the heating film is an aluminum film.

Further, the heating film is connected with a temperature control module for controlling a temperature of the heating film.

Further, the locking structure includes a mounting block for mounting the temperature control module; and the mounting block is provided with a receiving slot for embedding the temperature control module.

Further, the mounting block includes a first clamping block and a second clamping block; and the flexible housing is sandwiched between the first clamping block and the second clamping block.

Further, the locking structure includes a hard block arranged at an edge of the flexible housing.

Further, a hard block is arranged on one side of the flexible housing opposite to the opening.

Further, the hard block includes a third clamping block and a fourth clamping block; and the flexible housing is sandwiched between the third clamping block and the fourth clamping block.

Compared with the prior art, the present disclosure has the beneficial effects below:

1. By designing the heating film that is detachably mounted in the integrally formed flexible housing, the heating film can be taken out of the integrally formed flexible housing when damaged, without scrapping the entire product, thus prolonging the service life of the product. The bag-shaped structure facilitates subsequent plugging of the heating film.

2. The aluminum film is used as the heating film, so that compared with the traditional heating film, the aluminum film has a reduced weight and has a lightweight advantage. The aluminum film has fast heat conduction and high heat conductivity, thus improving the heating efficiency of the product. The aluminum film is conveniently plugged into the integrally formed flexible housing due to appropriate rigidity and hardness, and can be fixed without glue. This simplifies the production process. In addition, an extra treating agent is not needed, which also avoids a weight increased caused by an adhesive and further reduces the weight.

3. By using the locking structure, the silica gel tray can be fixed after being rolled up, to facilitate storage and save a storage space.

4. The hard block can be used to prevent upwarp. This avoids the problem of an edge upwarp caused by long-time use or storage.

5. The flexible housing is integrally formed directly through a mold, and the bag-shaped structure can be directly formed without pre-cutting or pre-assembling.

### BRIEF DESCRIPTION OF THE DRAWINGS

FIG. 1 is a three-dimensional diagram of an improved warming tray according to an embodiment of the present disclosure, viewed in a first angle;

FIG. 2 is a three-dimensional diagram of an improved warming tray according to an embodiment of the present disclosure, viewed in a second angle;

FIG. 3 is a three-dimensional diagram of a mounting block of an improved warming tray according to an embodiment of the present disclosure;

FIG. 4 is a three-dimensional diagram of a second clamping block of a mounting block of an improved warming tray according to an embodiment of the present disclosure;

FIG. 5 is a three-dimensional diagram of a first clamping block of a mounting block of an improved warming tray according to an embodiment of the present disclosure;

FIG. 6 is a three-dimensional diagram of a hard block of an improved warming tray according to an embodiment of the present disclosure;

FIG. 7 is a three-dimensional diagram of a fourth clamping block of a hard block of an improved warming tray according to an embodiment of the present disclosure;

FIG. 8 is a three-dimensional diagram of a third clamping block of a hard block of an improved warming tray according to an embodiment of the present disclosure; and

FIG. 9 is a schematic diagram of a flexible housing and a heating film of an improved warming tray according to an embodiment of the present disclosure (showing a state of the heating film being plugged into the flexible housing).

Numerals in the accompanying drawings: 1: flexible housing; 2: mounting block; 20: receiving slot; 21: first clamping block; 22: second clamping block; 3: hard block; 30: third clamping block; 31: fourth clamping block; and 4: heating film.

### DETAILED DESCRIPTION OF THE EMBODIMENTS

The technical solutions in the embodiments of the present disclosure will be clearly and completely described below with reference to the drawings in the embodiments of the present disclosure, and it is obvious that the described embodiments are only a part of the embodiments of the present disclosure but not all of them. All other embodiments obtained by a person of ordinary skill in the art based on the embodiments of present invention without making creative efforts shall fall within the protection scope of present invention.

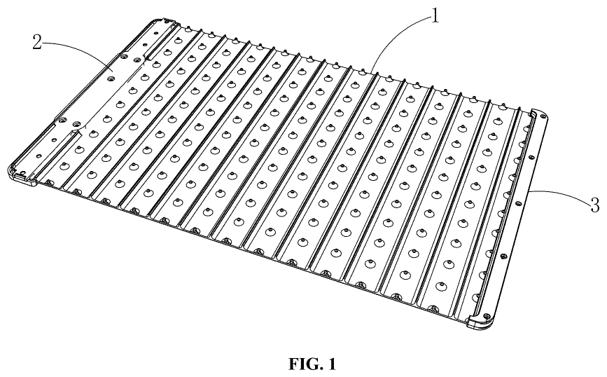

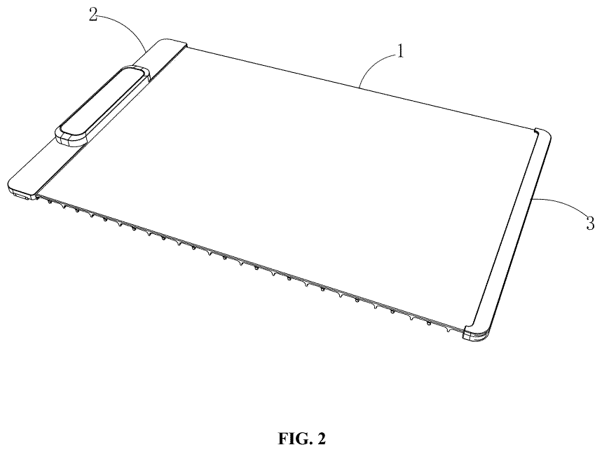

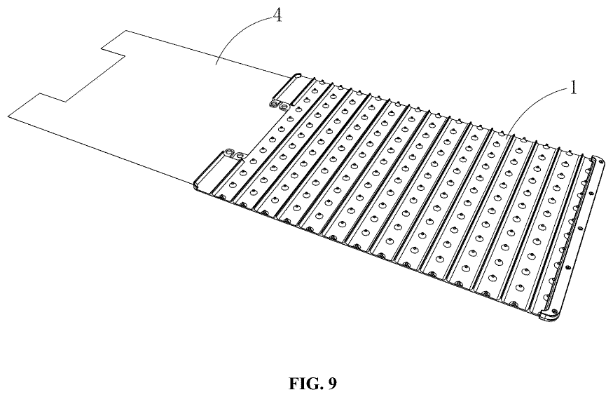

Referring to FIG. 1, FIG. 2, and FIG. 9, an embodiment of the present disclosure provides an improved warming tray, including: an integrally formed flexible housing 1 and a locking structure arranged at an edge of the flexible housing 1. The locking structure is configured to lock a rolled state of the improved warming tray and prevent an edge of the flexible housing 1 from being upwarped; at least one end of the flexible housing 1 has an opening formed into a bag-shaped structure; a heating film is detachably arranged in the flexible housing 1; and the heating film is put into the flexible housing 1 or taken out of the flexible housing 1 through the opening. By designing the heating film that is detachably mounted in the integrally formed flexible housing 1, the heating film can be taken out of the integrally formed flexible housing 1 when damaged, without scrapping the entire product, thus prolonging the service life of the product. The bag-shaped structure facilitates subsequent plugging of the heating film. Furthermore, an extra treating agent is not needed, which also avoids a weight increased caused by an adhesive and further reduces the weight. Specifically, the integrally formed flexible housing 1 is bag-shaped, so that the heating film can be placed into the flexible housing 1 from the opening. Through this split type design, the heating film can be taken out of the integrally formed flexible housing 1 when damaged, without replacing the entire product, thus prolonging the service life of the product. Preferably, the aluminum film is used as the heating film, so that compared with the traditional heating film, the weight is reduced, and the aluminum film has a lightweight advantage. The aluminum film has fast heat conduction and high heat conductivity, thus improving the heating efficiency of the product. The aluminum film is conveniently plugged into the integrally formed flexible housing 1 due to appropriate rigidity and hardness, and can be fixed without glue, and can be further fixed in the housing without using an adhesive. Fixing without glue simplifies the production process. The aluminum film can also be rolled, so that the aluminum film and the integrally formed flexible housing 1 can be rolled up together for storage.

Referring to FIG. 1 and FIG. 2, the heating film is connected with a temperature control module for controlling a temperature of the heating film. In this embodiment, the heating film has the temperature control module, so that the temperature of the heating film can be controlled. The temperature control module is an existing module. The temperature of the heating film is usually controlled by adjusting a resistance value of a heating wire of the heating film. These belong to the prior art and will not be elaborated here. Preferably, the locking structure includes a mounting block 2 for mounting the temperature control module; and the mounting block 2 is provided with a receiving slot 20 for embedding the temperature control module. The mounting block 2 can be designed to place the temperature control module, and the overall temperature control module is block-shaped, which can be placed in the receiving slot 20, so that the product has higher consistency, and damage to the temperature control module is also avoided.

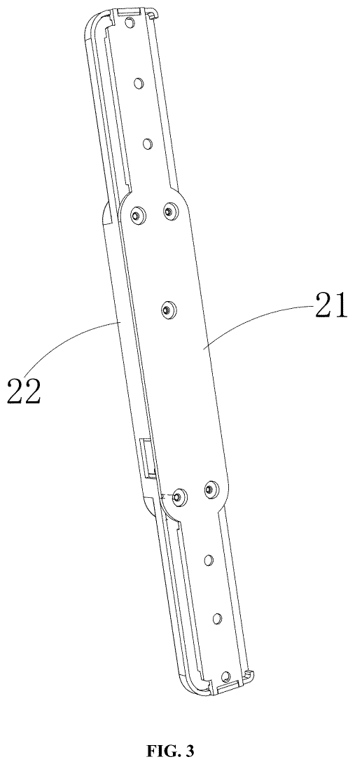

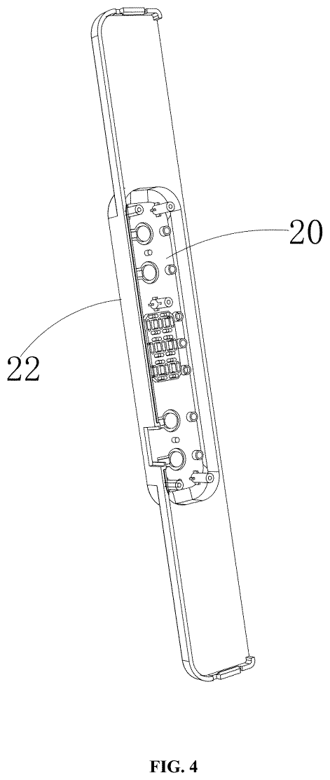

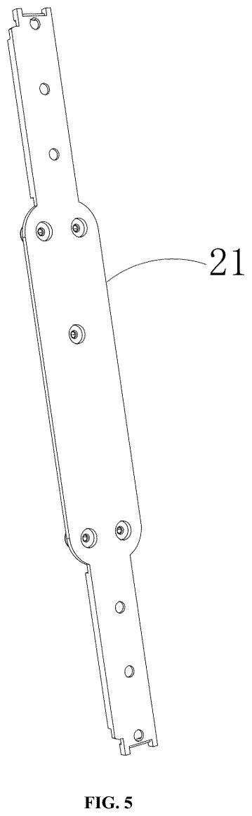

To further optimize the above solution, referring to FIG. 1 to FIG. 5, the mounting block 2 includes a first clamping block 21 and a second clamping block 22. The flexible housing 1 is sandwiched between the first clamping block 21 and the second clamping block 22. After the heating film is arranged into the flexible housing 1 from the opening, the opening of the integrally formed flexible housing 1 can be closed by the mounting block 2. The closing mode can be clamping, namely, the mounting block 2 is composed of the first clamping block 21 and the second clamping block 22, and the integrally formed flexible housing 1 can be sandwiched between them. The above receiving slot 20 in the second clamping block 22 is refined to accommodate the temperature control module. Several connecting columns are arranged on one side of the first clamping block 21 facing the second clamping block 22, which facilitates fixed connection between the first clamping block 21 and the second clamping block 22 through a screw.

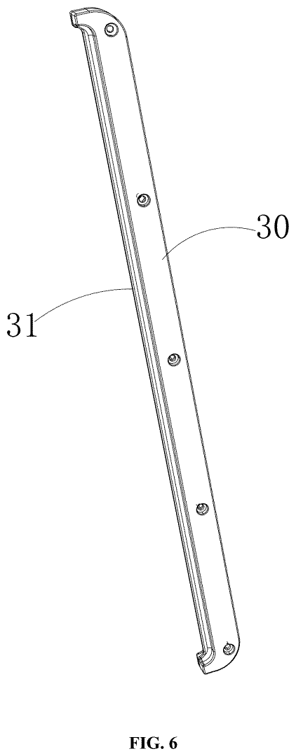

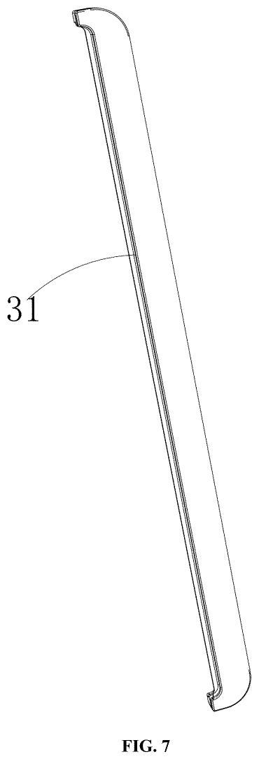

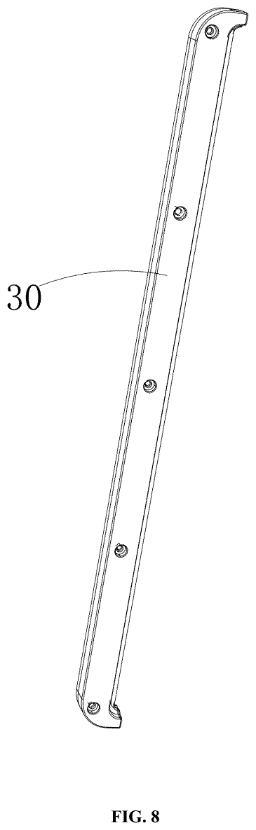

Referring to FIG. 1, FIG. 2, FIG. 6, FIG. 7, and FIG. 8, the locking structure includes a hard block 3 arranged at an edge of the flexible housing 1. In this embodiment, the hard block 3 is arranged on the other side of the integrally formed flexible housing 1, to prevent upwarp. This avoids the problem of an edge upwarp caused by long-time use or storage. Preferably, the hard block 3 includes a third clamping block 30 and a fourth clamping block 31; and the flexible housing is sandwiched between the third clamping block 30 and the fourth clamping block 31. The hard block 3 can also be designed to be composed of two clamping blocks which can clamp the other side of the integrally formed flexible housing 1.

Referring to FIG. 1 to FIG. 8, by using the locking structure, the silica gel tray can be fixed after being rolled up, to facilitate storage and save a storage space. A specific locking mode can be achieved by clamping, magnetic suction, adhesion, binding, or the like. Preferably, locking can be achieved using the above mounting block 2 and the above hard block 3. The mounting block and the hard block can be designed to be magnetic or designed with clamping structures or designed with hook and loop fasteners for fastening or designed with ties. Locking measures are made on the mounting block 2 and the hard block 3, so that the costs can be reduced, and the volume of the product can be reduced.

Referring to FIG. 1 to FIG. 8, the flexible housing 1 is integrally formed directly through a mold, and the bag-shaped structure can be directly formed without pre-cutting or pre-assembling.

Although the embodiments of the present disclosure have been shown and described, it can be understood by those of ordinary skill in the art that various changes, modifications, substitutions, and variations can be made to these embodiments without departing from the principle and spirit of the present disclosure. The scope of the present disclosure is defined by the accompanying claims and their equivalents.

What is claimed is:

1. An improved warming tray, comprising: an integrally formed flexible housing and a locking structure arranged at an edge of the flexible housing, wherein the locking structure is configured to lock a rolled state of the improved warming tray and prevent an edge of the flexible housing from being upwarped; at least one end of the flexible housing has an opening formed into a bag-shaped structure; a heating film is detachably arranged in the flexible housing; and the heating film is put into the flexible housing or taken out of the flexible housing through the opening.

2. The improved warming tray according to claim 1, wherein the heating film is an aluminum film.

3. The improved warming tray according to claim 1, wherein the heating film is connected with a temperature control module for controlling a temperature of the heating film.

4. The improved warming tray according to claim 3, wherein the locking structure comprises a mounting block for mounting the temperature control module; and the mounting block is provided with a receiving slot for embedding the temperature control module.

5. The improved warming tray according to claim 4, wherein the mounting block comprises a first clamping block and a second clamping block; and the flexible housing is sandwiched between the first clamping block and the second clamping block.

6. The improved warming tray according to claim 1, wherein the locking structure comprises a hard block arranged at an edge of the flexible housing.

7. The improved warming tray according to claim 6, wherein the hard block comprises a third clamping block and a fourth clamping block; and the flexible housing is sandwiched between the third clamping block and the fourth clamping block.
